(19) United States
(12) Patent Application Publication
(10) Pub. No.: US 2014/0320943 A1
(43) Pub. Date: Oct. 30, 2014

(54) OPTICAL SCANNING DEVICE

(71) Applicant: DENSO CORPORATION, KARIYA-CITY (JP)

(72) Inventors: Koichi OYAMA, Nagoya-city (JP); Hideaki NISHIKAWA, Nagoya-city (JP); Akio TSUGE, Miyoshi-city (JP); Kenichi SAKAI, Aichi-gun (JP); Hiroyuki WADO, Toyota-city (JP)

(73) Assignee: DENSO CORPORATION, KARIYA-CITY (JP)

(21) Appl. No.: 14/258,130

(22) Filed: Apr. 22, 2014

(30) Foreign Application Priority Data
Apr. 26, 2013 (JP) 2013-94247

(51) Int. Cl. G02B 26/08

(52) U.S. Cl. CPC G02B 26/0858
USPC 359/198.1

(57) ABSTRACT

An optical scanning device has a reflecting portion and a supporting body for supporting the reflecting portion. The reflecting portion has a reflecting surface for reflecting light beam. A pair of outside beam members is arranged between the reflecting portion and the supporting body in a longitudinal direction of the device. The device also has a first driving portion, one end of which is connected to the supporting body, while the other end of which is connected to a driving point of the reflecting portion. When the first driving portion is inflected, the reflecting portion is oscillated in a twisting vibration manner at a first axis. The driving point of the reflecting portion is located at a position separated from the first axis.

### CROSS REFERENCE TO RELATED APPLICATION

This application is based on Japanese Patent Application No. 2013-094247 filed on Apr. 26, 2013, the disclosure of which is incorporated herein by reference.

### FIELD OF TECHNOLOGY

The present disclosure relates to an optical scanning device for scanning optical beam.

### BACKGROUND

In recent years, several kinds of optical scanning devices are proposed, to which MEMS (Micro Electro Mechanical System) technology is applied in order to reduce a physical size of the optical scanning device. According to such a prior art device, a reflecting portion for reflecting light beam is displaced by a piezoelectric driving portion in order to scan the light beam. For example, as disclosed in Japanese Patent Publication No. 2008-040240, a piezoelectric driving portion having a bellows-type structure is used in order to increase vibrational angle of a reflecting portion.

Since the piezoelectric driving portion of the above prior art has the bellows-type structure and thereby a total length of an optical scanning device becomes larger, a minimum resonant frequency becomes smaller. When the minimum resonant frequency is small, the optical scanning device may be adversely affected by disturbance vibration (for example, vehicle vibration).

### SUMMARY OF THE DISCLOSURE

The present disclosure is made in view of the above problem. It is an object of the present disclosure to provide an optical scanning device, according to which a minimum resonant frequency does not become smaller even when a vibrational angle of a reflecting portion is made larger.

According to a feature of the present disclosure, an optical scanning device has a reflecting portion having a reflecting surface for reflecting light beam. The device further has a pair of outside beam members, each of which is formed at both longitudinal sides of the reflecting portion along a first axis. The first axis passes through a center of the reflecting portion. The device further has a supporting body for supporting the reflecting portion via the pair of the outside beam members. The device has a first driving portion, one end of which is connected to the supporting body and the other end of which is connected to a driving point of the reflecting portion. When the first driving portion is inflected, the driving point of the reflecting portion is correspondingly displaced so as to oscillate the reflecting portion in a twisting vibration manner at the first axis. The driving point of the reflecting portion is located at a position separated from the first axis.

According to the above feature of the present disclosure, the reflecting portion is supported by the supporting body via the pair of the outside beam members and the first driving portion. As a result, rigidity of the reflecting portion is increased as a whole and a minimum resonant frequency of the reflecting portion becomes higher. According to the above feature, it is also possible to make vibrational angle of the reflecting portion larger.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic top view showing a structure of an optical scanning device 1 according to a first embodiment of the present disclosure;

FIG. 2 is a schematic cross sectional view taken along a line II-II in FIG. 1;

FIG. 3 is a schematic cross sectional view taken along a line in FIG. 1;

FIG. 4 is a schematically enlarged top view showing a structure of relevant portions around a first driving portion 9 of the optical scanning device 1;

FIG. 5 is a schematic view showing a reflecting portion 3, which is oscillated at a first axis 18;

FIGS. 6A and 6B are schematic views, each showing an inner peripheral portion 13 which is oscillated at a second axis 21;

FIG. 7 is a schematic top view showing a structure of an optical scanning device 1 according to a second embodiment of the present disclosure;

FIG. 8 is a schematic top view showing a structure of an optical scanning device 1 according to a third embodiment of the present disclosure;

FIG. 9 is a schematic top view showing a structure of an optical scanning device 1 according to a fourth embodiment of the present disclosure;

FIG. 10 is a schematic top view showing a structure of an optical scanning device 1 according to a fifth embodiment of the present disclosure; and

FIG. 11 is a schematic cross sectional view taken along a line XI-XI in FIG. 10.

### DETAILED DESCRIPTION OF THE EMBODIMENTS

The present disclosure will be explained hereinafter by way of multiple embodiments. The same reference numerals are given to the same or similar portions and/or structures throughout the embodiments, for the purpose of eliminating repeated explanation.

### First Embodiment

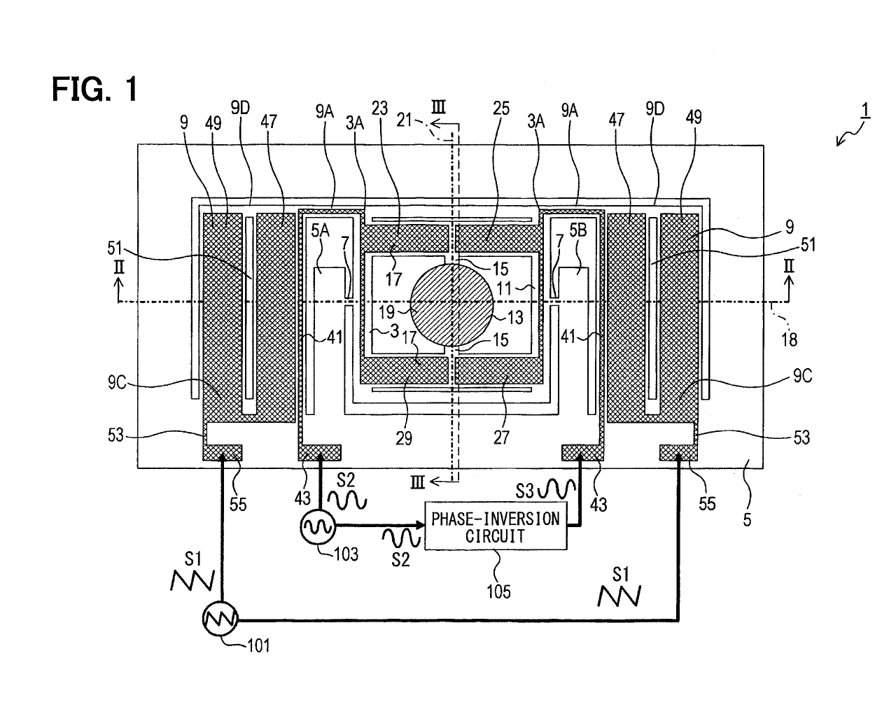

A structure of an optical scanning device 1 will be explained with reference to FIGS. 1 to 6. The optical scanning device 1 is composed of a reflecting portion 3, a supporting body 5, a pair of outside beam members 7, a pair of first driving portions 9 and so on.

The reflecting portion 3 is composed of an outer peripheral portion 11, an inner peripheral portion 13, a pair of inside beam members 15 and a second driving portion 17.

The outer peripheral portion 11 is a rectangular frame, within which the inner peripheral portion 13 of a disc shape and the second driving portion 17 are arranged. The outer peripheral portion 11 has the outside beam members 7 at its outer sides in a longitudinal direction. Each of the outside beam members 7 is a bar-shaped member. Each of the outside beam members 7 is located on a straight line extending in the longitudinal direction, wherein the straight line passes through a center of the inner peripheral portion 13. Hereinafter, the straight line is also referred to as a first axis 18.

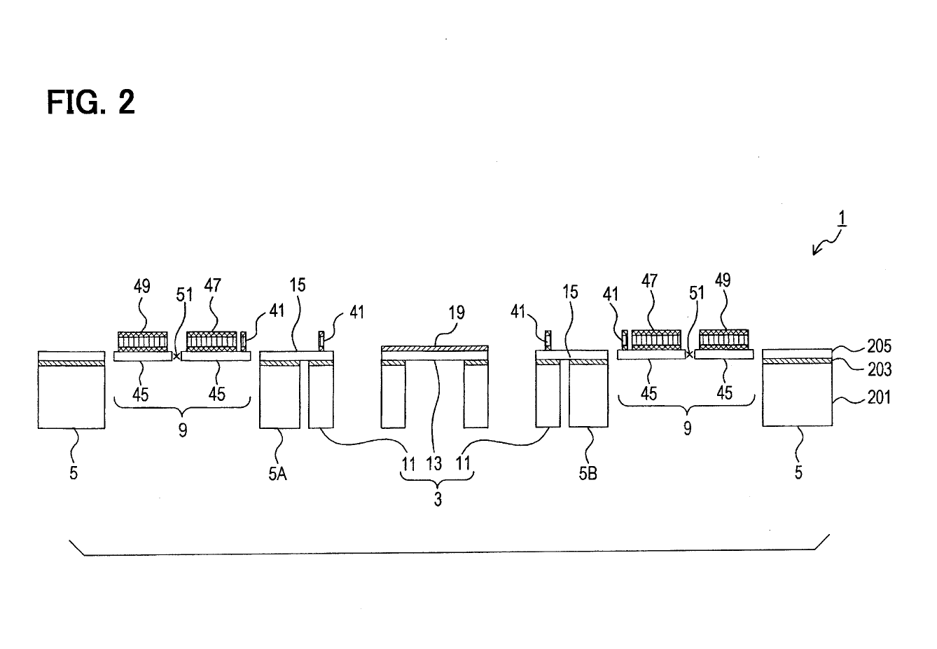

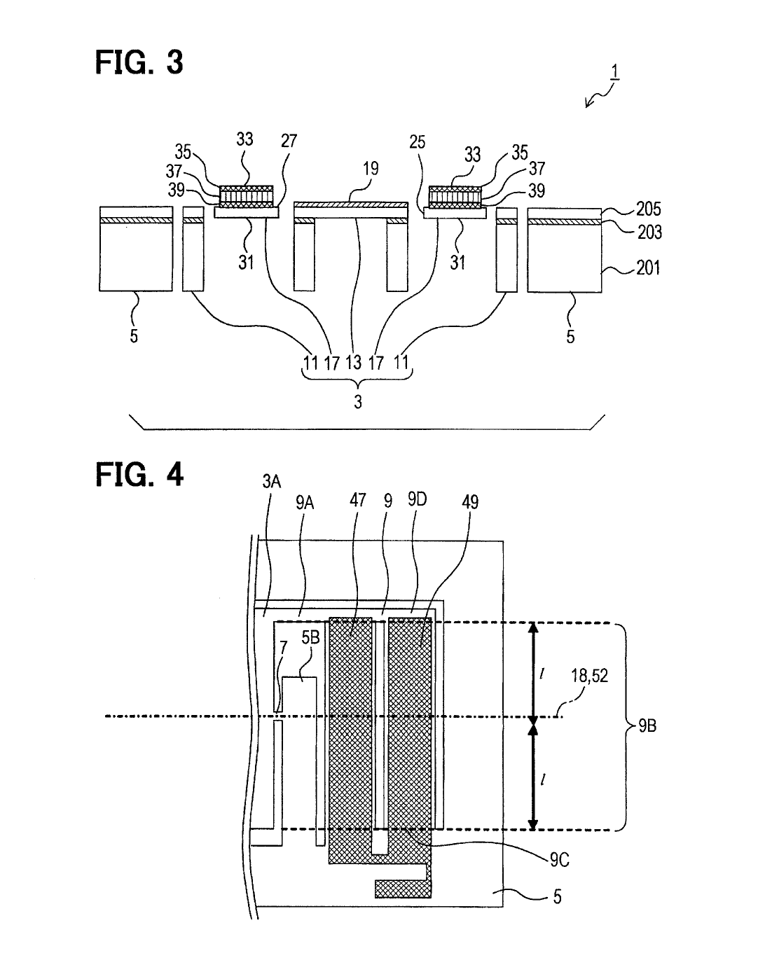

The inner peripheral portion 13 has a reflecting surface 19 on one of surfaces of the inner peripheral portion 13. The reflecting surface 19 is formed in a whole area of the surface of the inner peripheral portion 13 for reflecting optical beam. The reflecting surface 19 is formed by a thin film made of aluminum and having a thickness of 0.2 μm. As shown in FIGS. 2 and 3, the inner peripheral portion 13 has a rib along its outer periphery. The thickness of the inner peripheral portion 13 inside of the rib is smaller than that of the outer peripheral portion 11.

The pair of inside beam members 15 connects the inner peripheral portion 13 to the outer peripheral portion 11 at both sides of the inner peripheral portion 13, so that the inner peripheral portion 13 is oscillated in a manner of twisting vibration. Each of the inside beam members 15 is a bar-shaped member. Each of the inside beam members 15 is located on a straight line extending in a direction (hereinafter, a second axis 21) perpendicular to the first axis 18, wherein the straight line passes through the center of the inner peripheral portion 13. As shown in FIGS. 2 and 3, a thickness of the outside beam members 7 as well as a thickness of the inside beam members 15 is smaller than that of the outer peripheral portion 11 and a pair of supporting arms 5A and 5B (explained below).

The second driving portion 17 is composed of four driving elements 23, 25, 27 and 29, each of which is capable of flexion deformity. Each of the driving elements 23, 25, 27 and 29 has the same structure to one another. The driving element 23 connects an upper-left portion of the outer peripheral portion 11 to a left-hand portion of the inside beam member 15 (hereinafter, also referred to as an upper-side beam member 15). The driving element 25 connects an upper-right portion of the outer peripheral portion 11 to a right-hand portion of the upper-side beam member 15. The driving element 27 connects a lower-right portion of the outer peripheral portion 11 to a right-hand portion of the inside beam member 15 (hereinafter, also referred to as a lower-side beam portion 15). The driving element 29 connects a lower-left portion of the outer peripheral portion 11 to a left-hand portion of the lower-side beam portion 15.

In the above explanation, “upper-left”, “upper-right”, “lower-left”, “lower-right”, “upper-side” and “lower-side” are used only in connection with FIG. 1 and only for the purpose of simplification of the explanation. In an actual use, the above “upper-left” and others do not always correspond to those of an actual device.

As shown in FIG. 3, each of the driving elements 23, 25, 27 and 29 is composed of a substrate 31 of a plate shape and a piezoelectric thin film 33 formed on a surface of the substrate 31. The piezoelectric thin film 33 has a well-known structure, which is composed of an upper-side electrode 35, a PZT (piezoelectric zirconate titanate) film 37 having a thickness of 3 μm and a lower-side electrode 39, wherein the electrodes 35 and 39 and the PZT film 37 are laminated in a vertical direction. Each of the upper-side and the lower-side electrodes 35 and 39 is formed by a laminated structure, wherein a platinum (Pt) film having a thickness of 0.2 μm and a titanium (Ti) film having a thickness of 0.1 μm are laminated to each other.

Each of the driving elements 23, 25, 27 and 29 is electrically connected to terminal portions 43 via wiring portions 41. Each of the terminal portions 43 is formed on the supporting body 5. Each of the wiring portions 41, which is formed on a connecting portion 9A (explained below) and a substrate 45, is connected to the terminal portion 43. As shown in FIG. 3, a thickness of the second driving portion 17 is smaller than that of the outer peripheral portion 11.

The supporting body 5 is a rectangular frame, within which the reflecting portion 3 and the pair of the first driving portions 9 are arranged. The supporting body 5 has the supporting arms 5A and 5B inside of the supporting body 5. The supporting arms 5A and 5B are arranged at both sides of the reflecting portion 3 in the longitudinal direction. In each of the outside beam members 7, one end of the outside beam member 7 is connected to the outer peripheral portion 11, while the other end of the outside beam member 7 is connected to the respective supporting arm 5A or 5B. As above, the pair of the supporting arms 5A and 5B supports the reflecting portion 3 via the pair of the outside beam members 7.

Each of the first driving portions 9 is formed at each of longitudinal sides of the reflecting portion 3. Each of the first driving portions 9 has the same structure to each other. A lower-side end 9C of the first driving portion 9 is connected to the supporting body 5, while an upper-side end 9D is connected to the reflecting portion 3. More exactly, the upper-side end 9D has the connecting portion 9A extending toward the reflecting portion 3 and a forward end of the connecting portion 9A is connected to an upper-side end 3A of the reflecting portion 3. The upper-side end 3A is arranged at a position (hereinafter, the driving point 3A), which is separated from the first axis 18 in the direction of the second axis 21.

Each of the first driving portions 9 is composed of the substrate 45 and two sheets of piezoelectric thin films 47 and 49 formed on the substrate 45. Each of the piezoelectric thin films 47 and 49 extends from the lower-side end 9C to the upper-side end 9D. A layered structure of the piezoelectric thin films 47 and 49 is the same to that of the piezoelectric thin film 33 of the second driving portion 17. A constant gap is formed between the piezoelectric thin films 47 and 49 in the direction of the first axis 18. The substrate 45 has a slit 51 between the piezoelectric thin films 47 and 49 of each first driving portion 9. Each of the slits 51 extends in the direction of the second axis 21

Each of the first driving portions 9 is capable of the flexion deformity by flexing actions of the piezoelectric thin films 47 and 49. A direction of the flexing action is a direction perpendicular to a sheet of FIG. 1, in which the upper-side end 9D is lifted up and/or down.

In FIG. 4, a reference 9B designates a portion of the piezoelectric thin films 47 and 49, which is deformable by the flexion deformity. A midpoint 52 of such deformable portion 9B is located on the first axis 18. Each of the piezoelectric thin films 47 and 49 is electrically connected to a terminal portion 55 via a wiring portion 53. The wiring portions 53 and the terminal portions 55 are formed on the supporting body 5.

The optical scanning device 1 can be manufactured, for example, in the following manner.

At first, an SOI (silicon on insulator) wafer is prepared. The SOI wafer is composed of a supporting layer of Si (silicon) having a thickness of 350 μm, an intermediate oxide film having a thickness of 2 μm and an active layer of Si (silicon) having a thickness of 10 μm, wherein those components are laminated in this order.

The SOI wafer is selectively etched in order to form the supporting body 5 (including the supporting arms 5A and 5B), the outside beam members 7, the substrate 45, the connecting portions 9A, the outer peripheral portion 11, the inside beam members 15 and the inner peripheral portion 13 (except for the reflecting surface 19). The above portions are formed as one integral unit. In this condition, as shown in FIGS. 2 and 3, each of the supporting body 5, a part of the inner peripheral portion 13 and the outer peripheral portion 11 has a supporting layer 201, an intermediate oxide layer 203 and an active layer 205. On the other hand, each of the outside beam members 7, the substrate 45, the connecting portions 9A, the inside beam members 15 and a remaining part of the inner peripheral portion 13 is composed of the active layer 205 but not having the supporting layer 201 and the intermediate oxide layer 203.

Thereafter, the reflecting surface 19, the piezoelectric thin films 33, 47 and 49, the wiring portions 41 and 53, the terminal portions 43 and 55 are formed on one of the surfaces of the SOI wafer.

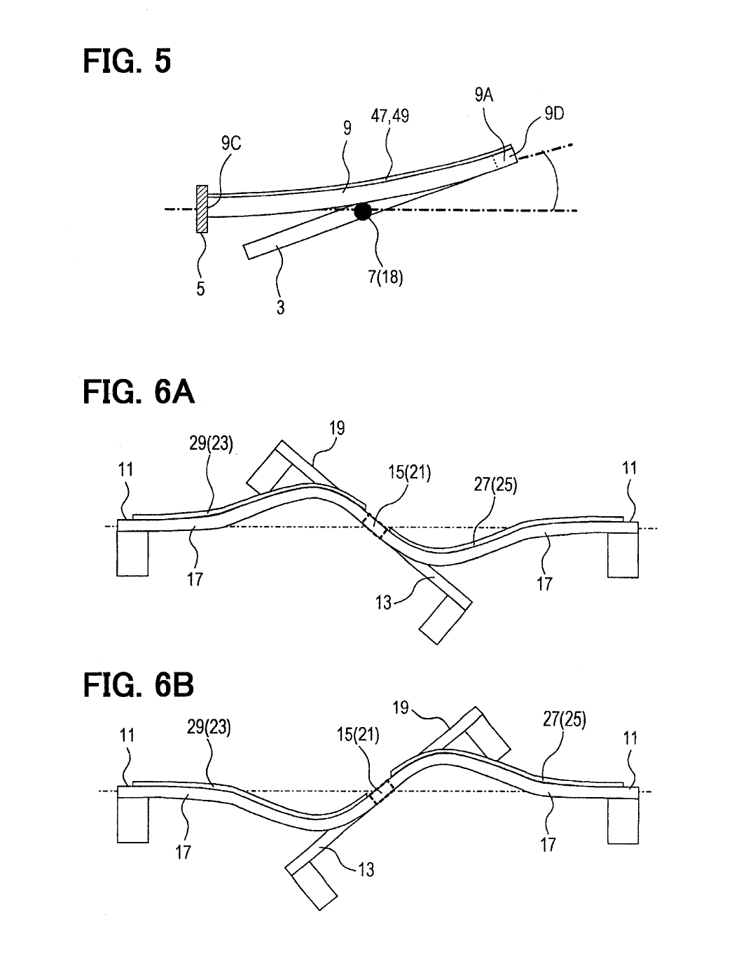

An operation of the optical scanning device 1 will be explained with reference to FIGS. 1, 5, 6A and 613. As shown in FIG. 1, a first driving-signal unit 101 is connected to each of the terminal portions 55 for supplying a driving signal S1 of 60 kHz to each of the terminal portions 55. Then, as shown in FIG. 5, the piezoelectric thin films 47 and 49 of the first driving portion 9 are inflected by the first driving signal S1. Since the upper-side end 3A (the driving point 3A) of the reflecting portion 3 is connected to the connecting portion 9A of each driving portion 9, the upper-side end 3A of the reflecting portion 3 is deformed in the direction perpendicular to the sheet of FIG. 1 (in an up-and-down direction in FIG. 5) by the inflection of the first driving portion 9.

As a result, the reflecting portion 3 is oscillated in a twisting vibration manner around the outside beam members 7 (that is, around the first axis 18). The vibration of the reflecting portion 3 is a non-resonant vibration.

A second driving-signal unit 103 is directly connected to one of the terminal portions 43, while the second driving-signal unit 103 is connected to the other terminal portion 43 via a phase-inversion circuit 105. As a result, a second driving signal S2 of 30 kHz is supplied to one of the terminal portions 43, while a third driving signal S3 of 30 kHz of the reversed phase is supplied to the other terminal portion 43. Then, as shown in FIGS. 6A and 6B, the second driving portion 17 is inflected by the second and third driving signals S2 and S3. As a result, the inner peripheral portion 13 is oscillated in a twisting vibration manner around the inside beam members 15 (that is, around the second axis 21). The vibration of the inner peripheral portion 13 is a resonant vibration.

As above, the reflecting surface 19 formed on the inner peripheral portion 13 of the reflecting portion 3 can be oscillated in each of directions around the first axis 18 and the second axis 21, so that reflected light reflected at the reflecting surface 19 can be scanned in a two-dimensional manner.

The present embodiment has the following advantages:

(1) The reflecting portion 3 is connected to the supporting body 5 via the outside beam members 7 and the first driving portions 9. Therefore, the rigidity of the reflecting portion 3 is increased as a whole and a minimum resonance frequency of the reflection portion 3 is increased.

(2) Each of the first driving portions 9 has two piezoelectric thin films 47 and 49. And each of the two thin films 47 and 49 inflected in the same direction. As a result, it is possible to increase vibrational angle of the reflecting portion 3. In addition, since the first driving portion 9 has the slit 51 between the two piezoelectric thin films 47 and 49, the first driving portion 9 is not easily inflected in such a direction different from an intended direction (that is, the direction perpendicular to the sheet of FIG. 1). As a result, the first driving portion 9 is more easily inflected in the intended direction and thereby the vibrational angle of the reflecting portion 3 can be further increased.

(3) Since the midpoint 52 of the deformable portion 9B of the first driving portion 9 is located on the first axis 18, a rotational center of the reflecting portion 3 oscillated by the first driving portion 9 comes much closer to the first axis 18. As a result, a force for deforming the outside beam members 7 in the direction perpendicular to the sheet of FIG. 1 (the direction in the up-and-down direction in FIG. 5) can be made smaller and thereby stress applied to the outside beam members 7 can be reduced. It is, therefore, possible to prevent the outside beam members 7 from being broken and possible to more smoothly oscillate the reflecting portion 3.

(4) In the optical scanning device 1, in addition to the twisting vibration of the reflecting portion 3 with respect to the supporting body 5, the inner peripheral portion 13 can be also oscillated with respect to the outer peripheral portion 11 in the twisting vibration manner. Accordingly, the reflected light reflected by the reflecting surface 19 can be scanned in the two dimensions.

### Second Embodiment

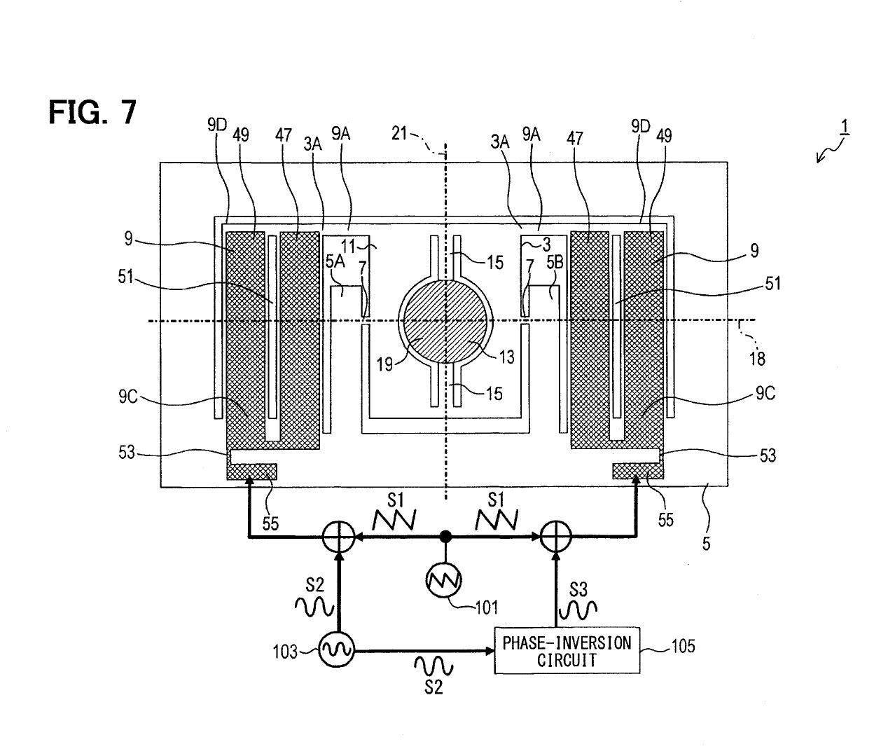

A structure of an optical scanning device 1 of a second embodiment (FIG. 7) is basically the same to that of the first embodiment. Hereinafter, different portions will be mainly explained.

In the same manner to the first embodiment, the reflecting portion 3 is composed of the outer peripheral portion 11, the inner peripheral portion 13 and the pair of inside beam members 15. However, the reflecting portion 3 does not have a structure corresponding to the second driving portion 17 of the first embodiment. In addition, the optical scanning device of the second embodiment does not have a structure corresponding to the wiring portions 41 and the terminal portions 43. The optical scanning device 1 can be manufactured by the same processes to those of the first embodiment.

An operation of the optical scanning device 1 will be explained with reference to FIGS. 5 and 7. The first driving-signal unit 101 is connected to each of the terminal portions 55 for supplying the driving signal S1 of 60 kHz to each of the terminal portions 55. Then, as shown in FIG. 5, the piezoelectric thin films 47 and 49 of the first driving portion 9 are inflected by the first driving signal S1. Since the upper-side end 3A (the driving point 3A) of the reflecting portion 3 is connected to the connecting portion 9A of each driving portion 9, the upper-side end 3A of the reflecting portion 3 is deformed in the direction perpendicular to the sheet of FIG. 7 (in the up-and-down direction in FIG. 5) by the inflection of the first driving portion 9.

As a result, the reflecting portion 3 is oscillated in the twisting vibration manner around the outside beam members 7 (that is, around the first axis 18). The vibration of the reflecting portion 3 is the non-resonant vibration.

In addition, the second driving-signal unit 103 is directly connected to one of the terminal portions 55, while the second driving-signal unit 103 is connected to the other terminal portion 55 via the phase-inversion circuit 105. As a result, the second driving signal S2 of 30 kHz is supplied to one of the terminal portions 55, at which the second driving signal S2 is overlapped with the first driving signal S1. And the third driving signal S3 of 30 kHz of the reversed phase is supplied to the other terminal portion 55, at which the third driving signal S3 is overlapped with the first driving signal S1.

According to the above superimposing supply of the driving signals S1, S2 and S3, each of the first driving portions 9 is at first deformed in the direction perpendicular to the sheet of FIG. 7 (in the up-and-down direction in FIG. 5) in response to the first driving signal S1, as explained above. In addition, one of the first driving portions 9 (for example, the right-hand driving portion) is further deformed in the direction perpendicular to the sheet of FIG. 7 (in the up-and-down direction in FIG. 5) in response to the second driving signal S2 of 30 kHz, while the other of the first driving portions 9 (for example, the left-hand driving portion) is further deformed in the direction perpendicular to the sheet of FIG. 7 (in the up-and-down direction in FIG. 5 but in the direction opposite to that of the right-hand driving portion) in response to the third driving signal S3 of 30 kHz in the reversed phase.

The inner peripheral portion 13 and the outer peripheral portion 11 form a torsionally coupled system having a vibrational mode, in which vibrational angle of the twisting vibration for the inner peripheral portion 13 at the second axis 21 becomes larger, while vibrational angle of the twisting vibration for the outer peripheral portion 11 at the second axis 21 becomes smaller.

For example, in the present embodiment, a ratio of the vibrational angle for the twisting vibration between the vibrational angle for the inner peripheral portion 13 and the vibrational angle for the outer peripheral portion 11 is set at ratio of 10 (ten) against 1 (one), that is, 10:1, and resonant frequency for the above vibrational mode is set at 30 kHz. Then, the above vibrational mode becomes energized, when the driving signal of 30 kHz is supplied to one of the first driving portions 9, while the driving signal of 30 kHz of the reversed phase is supplied to the other of the first driving portions 9. As a result, the vibration of the inner peripheral portion 13 is largely resonated.

As above, the reflecting surface 19 formed on the inner peripheral portion 13 of the reflecting portion 3 can be independently oscillated at the first axis 18 and at the second axis 21. Therefore, the reflected light reflected by the reflecting surface 19 can be scanned in the two dimensions.

The second embodiment has the same advantages to those of the first embodiment.

In addition, it is possible to simplify the structure and to reduce a size of the optical scanning device 1, because the optical scanning device of the second embodiment does not have those structures corresponding to the second driving portion 17, the wiring portions 41 and the terminal portions 43 of the first embodiment.

### Third Embodiment

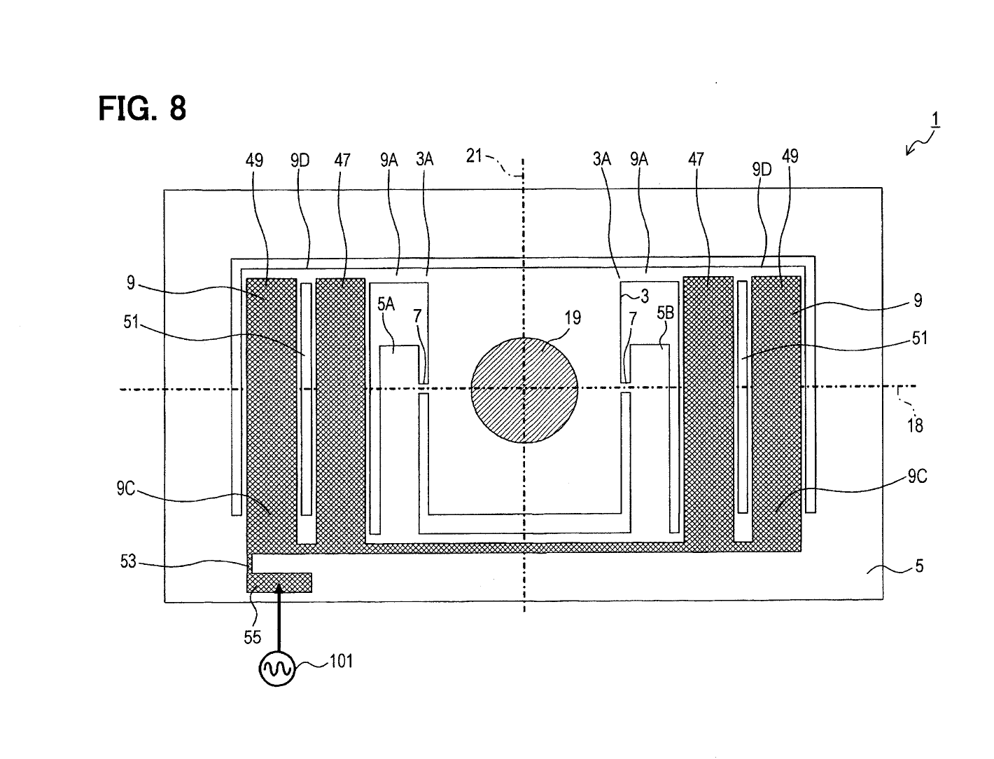

A structure of an optical scanning device 1 of a third embodiment (FIG. 8) is also basically the same to that of the first embodiment. Hereinafter, different portions will be mainly explained.

As shown in FIG. 8, the reflecting portion 3 does not have a structure corresponding to the outer peripheral portion 11 and the inner peripheral portion 13 of the first embodiment. In other words, the outer peripheral portion 11 and the inner peripheral portion 13 are not separately defined but formed as one integral portion. Therefore, the reflecting portion 3 does not have a structure corresponding to the inside beam members 15. The reflecting surface 19 is formed at a center of the reflecting portion 3. Furthermore, the wiring portion 53 and the terminal portion 55 are commonly provided on the supporting body 5 for the two pairs of the first driving portions 9. The optical scanning device 1 can be manufactured by the same processes to those of the first embodiment.

An operation of the optical scanning device 1 will be explained with reference to FIGS. 5 and 8. The first driving-signal unit 101 is connected to the terminal portion 55 for supplying the driving signal S1 of 60 kHz to the terminal portion 55. Then, as shown in FIG. 5, the piezoelectric thin films 47 and 49 of the first driving portion 9 are inflected by the first driving signal S1. Since the upper-side end 3A′ (the driving point 3A) of the reflecting portion 3 is connected to the connecting portion 9A of the first driving portion 9, the upper-side end 3A of the reflecting portion 3 is deformed in the direction perpendicular to the sheet of FIG. 8 (in the up-and-down direction in FIG. 5) by the inflection of the first driving portion 9. As a result, the reflecting portion 3 is oscillated in the twisting vibration manner around the beam members 7 (that is, around the first axis 18).

Accordingly, the reflecting surface 19 formed on the reflecting portion 3 can be oscillated at the first axis 18. Therefore, the reflected light reflected by the reflecting surface 19 can be scanned in a single dimension.

The third embodiment has almost the same advantages to those of the first embodiment.

In addition, it is possible to simplify the structure of the reflecting portion 3.

### Fourth Embodiment

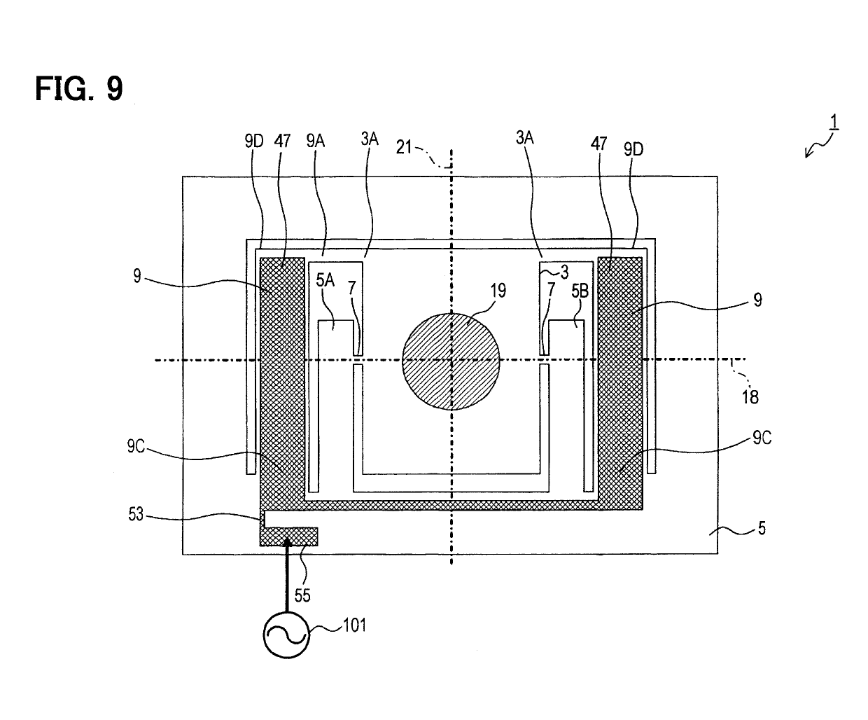

A structure of an optical scanning device 1 of a fourth embodiment (FIG. 9) is also basically the same to that of the third embodiment. Hereinafter, different portions will be mainly explained.

As shown in FIG. 9, each of the first driving portions 9 has one piezoelectric thin film 47 but does not have a structure corresponding to the slit 51 of the first embodiment.

The optical scanning device 1 can be manufactured by the same processes to those of the first embodiment.

An operation of the optical scanning device 1 will be explained with reference to FIGS. 5 and 9. The first driving-signal unit 101 is connected to the terminal portion 55 for supplying the driving signal S1 of 60 kHz to the terminal portion 55. Then, as shown in FIG. 5, each of the piezoelectric thin films 47 of the first driving portion 9 is inflected by the first driving signal S1. Since the upper-side end 3A (the driving point 3A) of the reflecting portion 3 is connected to the connecting portion 9A of the first driving portion 9, the upper-side end 3A of the reflecting portion 3 is deformed in the direction perpendicular to the sheet of FIG. 9 (in the up-and-down direction in FIG. 5) by the inflection of the first driving portion 9. As a result, the reflecting portion 3 is oscillated in the twisting vibration manner around the beam members 7 (that is, around the first axis 18).

Accordingly, the reflecting surface 19 formed on the reflecting portion 3 can be oscillated at the first axis 18. Therefore, the reflected light reflected by the reflecting surface 19 can be scanned in a single dimension.

The fourth embodiment has almost the same advantages to those of the third embodiment.

In addition, it is possible to simplify the structure of the first driving portion 9.

### Fifth Embodiment

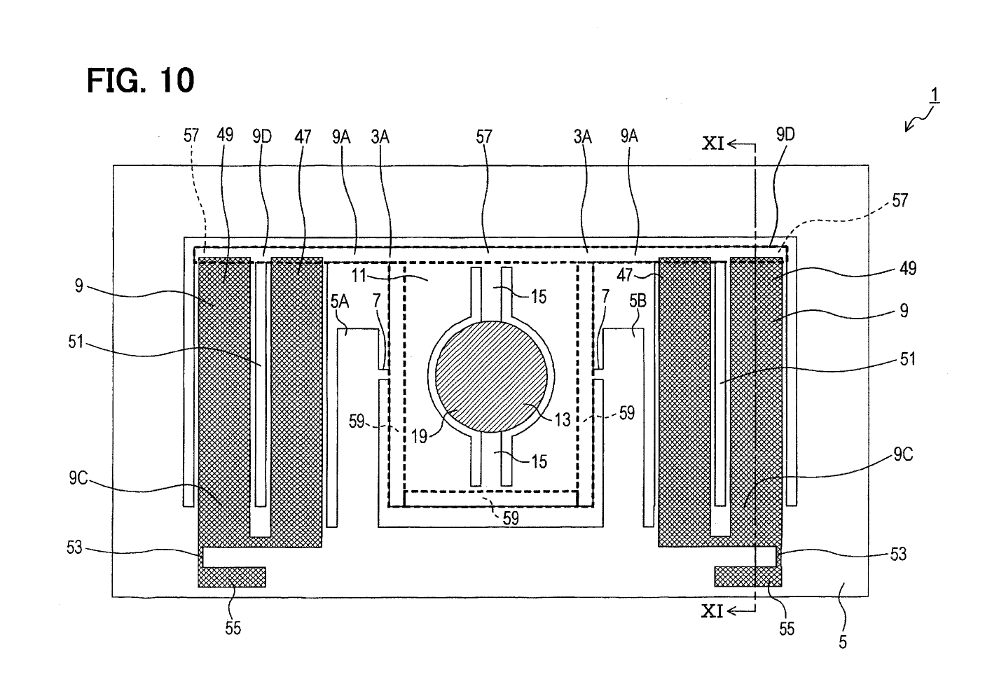

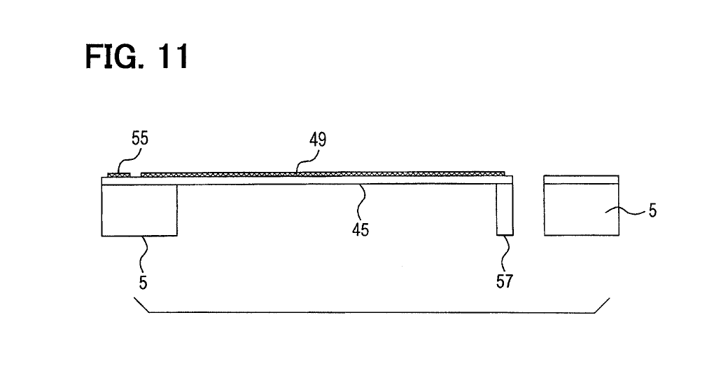

A structure of an optical scanning device 1 of a fifth embodiment (FIGS. 10 and 11) is basically the same to that of the second embodiment. Hereinafter, different portions will be mainly explained.

As shown in FIGS. 10 and 11, the optical scanning device 1 has a rib 57 and a rib 59. The rib 57 is formed in such an area including the upper-side ends 9D of the first driving portions 9, the connecting portions 9A, and an upper-side end of the outer peripheral portion 11. The rib 59 is formed at three outer peripheral sides of the outer peripheral portion 11, except for the upper-side end at which the rib 57 is formed.

As shown in FIG. 11, the rib 57 is formed as a portion of the substrate 45, a thickness of which is made larger than that of other portions. In a similar manner, a thickness of the substrate for the rib 59 is made larger than that of the other portions.

The ribs 57 and 59 can be formed in the process for etching the SOI wafer. More exactly, the ribs 57 and 59 are formed in such a way that portions of the SOI wafer corresponding to the ribs 57 and 59 are not etched in the etching process.

The optical scanning device 1 can be operated in the same manner to that of the second embodiment.

The fifth embodiment has almost the same advantages to those of the second embodiment.

In addition, the upper-side end 9D and the connecting portion 9A are not easily bent when the first driving portions 9 are inflected, because the optical scanning device 1 has the rib 57. As a result, the flexing action of the first driving portions 9 can be effectively transmitted to the reflecting portion 3 to thereby further increase the vibrational angle of the reflecting portion 3.

In addition, the outer peripheral portion 11 is not easily bent when the first driving portions 9 are inflected, because the optical scanning device 1 has the rib 59. As a result, the flexing action of the first driving portions 9 can be effectively transmitted to the reflecting portion 3 to thereby further increase the vibrational angle of the reflecting portion 3.

The present disclosure should not be limited to the above embodiments but can be modified in various manners without departing from spirits of the present disclosure.

For example, in the above first to fifth embodiments, the first driving portion may be formed only on one longitudinal side of the reflecting portion 3.

In the above first to fifth embodiments, the midpoint 52 of the deformable portion 9B of the first driving portion 9 may be located at another point separated from the first axis 18.

What is claimed is:

1. An optical scanning device comprising:
a reflecting portion having a reflecting surface for reflecting light beam;
a pair of outside beam members arranged on a first axis and connected to both longitudinal sides of the reflecting portion, the outside beam members being capable of twisting vibration, wherein the first axis passes through a center of the reflecting portion;
a supporting body for supporting the reflecting portion via the pair of the outside beam members; and
a first driving portion, a first end of which is connected to the supporting body and a second end of which is connected to a driving point of the reflecting portion,
wherein the second end of the first driving portion is capable of being inflected so as to displace the driving point, so that the reflecting portion is oscillated in a twisting vibration manner at the first axis, and
wherein the driving point is located at a position separated from the first axis.

2. The optical scanning device according to claim 1, wherein the reflecting portion is composed of;
an outer peripheral portion connected to the pair of the outside beam members at both longitudinal sides of the outer peripheral portion;
an inner peripheral portion having the reflecting surface; and
a pair of inside beam members arranged on a second axis and connecting the outer peripheral portion to the inner peripheral portion in the twisting vibration manner, wherein the second axis passes through a center of the inner peripheral portion.

3. The optical scanning device according to claim 2, wherein the reflecting portion has;
a second driving portion, which is capable of being inflected so as to oscillate the inner peripheral portion in the twisting vibration manner at the second axis.

4. The optical scanning device according to claim 1, wherein
the first driving portion has a slit extending in a direction perpendicular to the first axis.

5. The optical scanning device according to claim 1, wherein
a midpoint of a deformable portion of the first driving portion is located on the first axis, wherein the midpoint corresponds to a midpoint in a direction perpendicular to the first axis.

6. The optical scanning device according to claim 1, wherein
the first driving portion has a rib at the driving point and a connecting portion, which connects the first driving portion to the driving point of the reflecting portion.
